(19) United States
(12) Patent Application Publication
(10) Pub. No.: US 2014/0168106 A1
(43) Pub. Date: Jun. 19, 2014

(54) APPARATUS AND METHOD FOR PROCESSING HANDWRITING INPUT

(71) Applicants: HAI-SEN LIANG, Shenzhen (CN); CHIH-SAN CHIANG, New Taipei (TW); HUA-DONG CHENG, Shenzhen (CN); HAI-JUN MAO, Shenzhen (CN); TE-JIA LIU, Shenzhen (CN)

(72) Inventors: HAI-SEN LIANG, Shenzhen (CN); CHIH-SAN CHIANG, New Taipei (TW); HUA-DONG CHENG, Shenzhen (CN); HAI-JUN MAO, Shenzhen (CN); TE-JIA LIU, Shenzhen (CN)

(21) Appl. No.: 13/741,395

(22) Filed: Jan. 15, 2013

(30) Foreign Application Priority Data
Dec. 14, 2012 (CN) 201210542196.8

(51) Int. Cl. G06F 3/0488

(52) U.S. Cl. CPC G06F 3/04883
USPC 345/173

(57) ABSTRACT

An apparatus for processing handwriting on a touch screen includes a touch display screen, a display control unit, a touch analyzing unit, and a processing unit. The touch analyzing unit determines coordinates of touches. The processing unit generates a prompt including a first operating point when touch coordinates are on the boundary of a word inputting box. When the coordinates of a touch position are on the first operating point, the processing unit reduces a size of a handwritten letters and displays the handwritten letters with reduced size, reduces the additional handwritten letters, and displays the additional handwritten letters with the reduced size in the display box at the end of the handwritten letters. A related method is also provided.

### BACKGROUND

1. Technical Field

The present disclosure relates to handwriting input technology and recognition, and particularly, to an apparatus and a method for processing handwriting input.

2. Description of the Related Art

Touch screens are found in electronic devices, and some touch input devices include a touch panel and an input device, such as stylus, for inputting handwriting on the touch panel. When a user inputs a long word having five or more characters, the input may appear to look like two or more words rather than one word because of the space between some adjacent characters. For example, a user inputting the word “something” may confuse people, who see the two words “some” and “thing” if the space between “e” and “t” is big enough. Moreover, the handwriting is commonly stored as a digital image without any correction to the words, and the size, the height, or the width of some characters of the input handwriting may be quite different from others, which results in an untidy look. Therefore, there is room for improvement within the art.

### BRIEF DESCRIPTION OF THE DRAWING

The components in the drawings are not necessarily drawn to scale, the emphasis instead being placed icon clearly illustrating the principles of the disclosure. Moreover, in the drawing, like reference numerals designate corresponding parts throughout the several views.

FIG. 1 is a block diagram of an apparatus for processing handwriting input, according to an exemplary embodiment.

FIG. 2 is a block diagram of a processing unit of the apparatus of FIG. 1, according to an exemplary embodiment.

FIG. 3 is a schematic diagram showing a first using state of handwriting inputting on the apparatus of FIG. 1, in accordance with an exemplary embodiment.

FIG. 4 is a schematic diagram showing a second using state of handwriting inputting on the apparatus of FIG. 1, in accordance with an exemplary embodiment.

FIG. 5 is a schematic diagram showing a third using state of handwriting inputting on the apparatus of FIG. 1, in accordance with an exemplary embodiment.

FIG. 6 is a schematic diagram showing a fourth using state of handwriting inputting on the apparatus of FIG. 1, in accordance with an exemplary embodiment.

FIG. 7 is a schematic diagram showing a fifth using state of handwriting inputting on the apparatus of FIG. 1, in accordance with an exemplary embodiment.

FIG. 8 is a flowchart of a method for processing handwriting input, in accordance with an exemplary embodiment.

### DETAILED DESCRIPTION

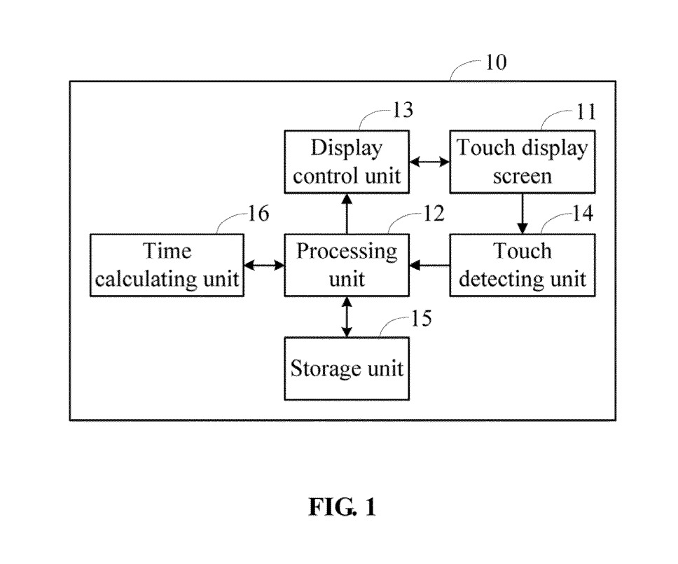

FIG. 1 shows a block diagram of an apparatus for processing handwriting input. The apparatus 10 is operated by a user via an input device 20. The input device 20 may be a stylus, a pen, or the like. The apparatus 10 includes a touch display screen 11, a processing unit 12, a display control unit 13, a touch analyzing unit 14, and a storage unit 15. The apparatus 10 may be a mobile phone, a tablet computer, or the like.

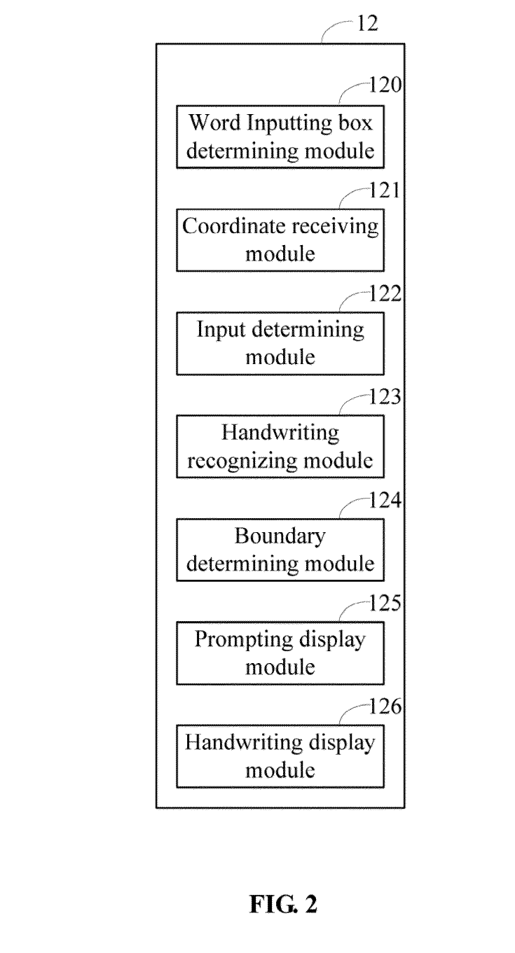

Referring to FIG. 2, the processing unit 12 includes an word inputting box determining module 120, a coordinate receiving module 121, an input determining module 122, a handwriting recognizing module 123, a boundary determining module 124, a prompting display module 125, and a handwriting display module 126.

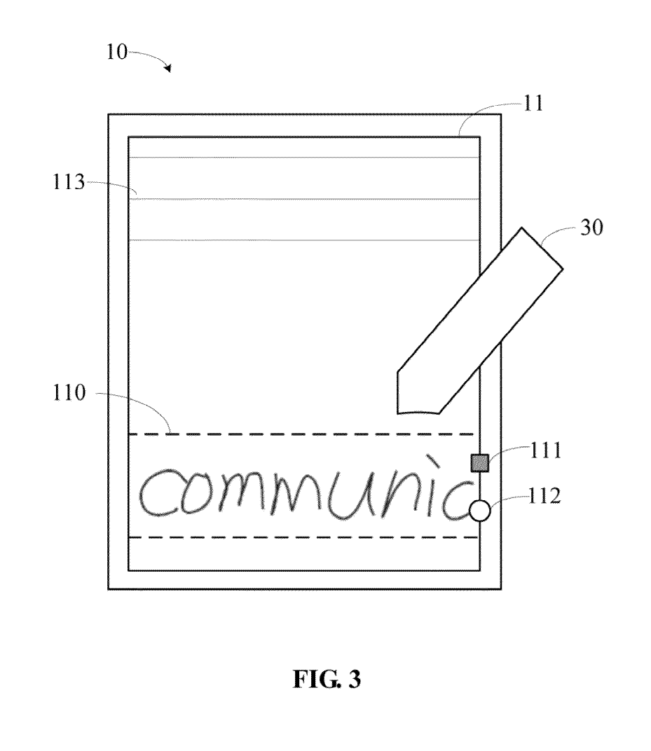

Referring to FIG. 3, when the input device 20 touches the touch display screen 11 to input handwriting, the touch analyzing unit 14 detects an initial touch position on the touch display screen 11. The storage unit 15 has a pre-stored word inputting box defining condition for defining an word inputting box 110. The word inputting box determining module 120 controls to display the word inputting box 110 on the touch display screen 11 for allowing the user to handwrite the letters therein. The word inputting box determining module 120 determines the word inputting box 110 according to the word inputting box defining condition stored in the storage unit 15. In the embodiment, according to the word inputting box defining condition, the size of the word inputting box 110 is equal to that of the touch display screen 11. In an alternative embodiment, according to the word inputting box defining condition, the size of the word inputting box 110 is smaller than that of the touch display screen 11 and is centered by the initial touch position. The storage unit 15 further has a pre-stored display box defining condition. The handwriting display module 126 controls the touch display screen 11 to display a display box thereon according to the display box defining condition, the display box displays one or more words input by the input device 20, zoomed out with a predetermined scaling factor.

The touch analyzing unit 14 determines coordinates of touch positions in response to touch signals generated by the touch display screen 11. The coordinate receiving module 121 receives the coordinates determined by the touch analyzing unit 14. When the input determining module 122 determines that no touch signals are being received from the touch display screen 11, the time calculating unit 16 is enabled by the input determining module 122 to calculate the elapse time for which no touch signals are being received. The input determining module 122 determines whether the time tracked by the time calculating unit 16 reaches a predetermined time to determine whether the input of a word is finished. If the touch analyzing unit 14 receives touch signals from the touch display screen 11 again before the time elapsed reaches the predetermined time, the input determining module 122 determines that the input of the word is continuing. The handwriting display module 126 controls the touch display screen 11 to display the unfinished word in the word inputting box 110. When the elapsed time is equal to the predetermined time, the handwriting recognizing module 123 determines that the input of the word is finished, and the handwriting display module 126 zooms the word out according to the predetermined scaling factor and controls the touch display screen 11 to display the zoomed out word in the display box.

The boundary determining module 124 determines whether the coordinates received by the coordinate receiving module 121 are on a predetermined boundary of the word inputting box 110 according to the word inputting box defining condition stored in the storage unit 15.

When the coordinates received by the coordinate receiving module 121 determined to be on or to cross any boundary of the word inputting box 110, the prompting display module 125 generates a prompt, and the display control unit 13 controls the touch display screen 11 to display the prompt. In the embodiment, the prompt includes a first operating point 111 and a second operating point 112 (as shown in FIG. 3) both being displayed on the boundary of the word inputting box 110. The handwriting display module 126 determines whether any coordinate determined by the touch analyzing unit 14, in response to a user's touch when the prompt is displayed on the touch display screen 11, is on the first operating point 111 or on the second operating point 112.

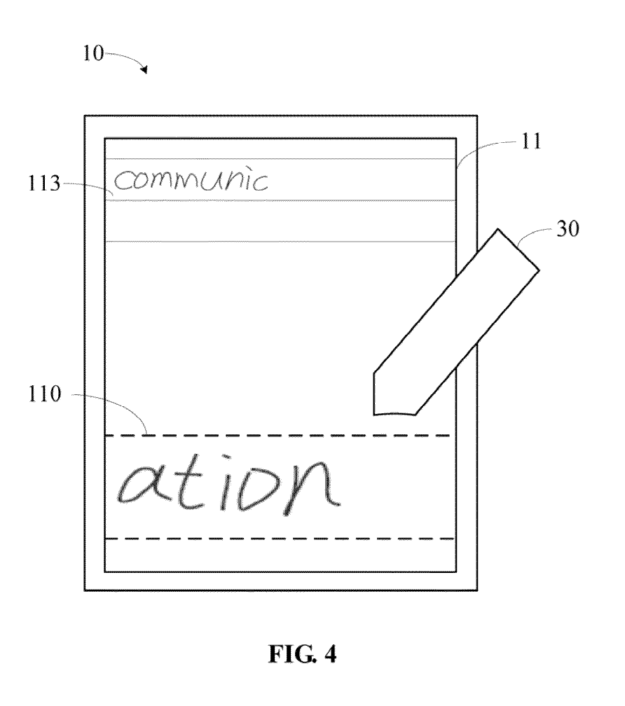

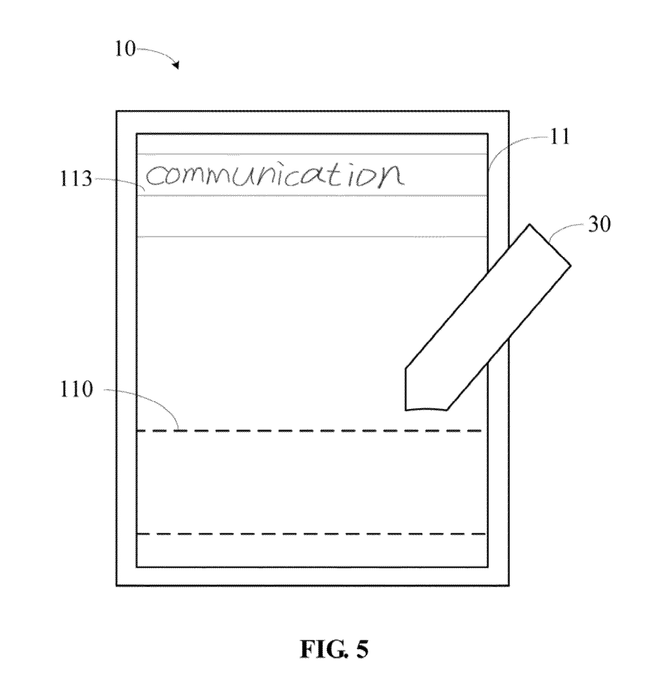

Referring to FIGS. 4 and 5, if the coordinates are on the first operating point 111, the handwriting display module 126 reduces a size of the handwritten letters, and displays the word with the reduced size in the display box 113. Then, the handwriting display module 126 erases the word so far displayed in the word inputting box 110. The handwriting display module 126 further reduces a size of the second word in the predetermined scaling factor, and controls the touch display unit 11 to display the second word with the reduced size in the display box 113, immediately following and joined to the word which had been displayed thereon, to combine the original word with the second word to form a single whole word. The second word immediately following the original word to form a whole word means that the space between the last character of the original word and the first character of the second word is much less than the space between word-ending and word-starting letters when two separate words are intended.

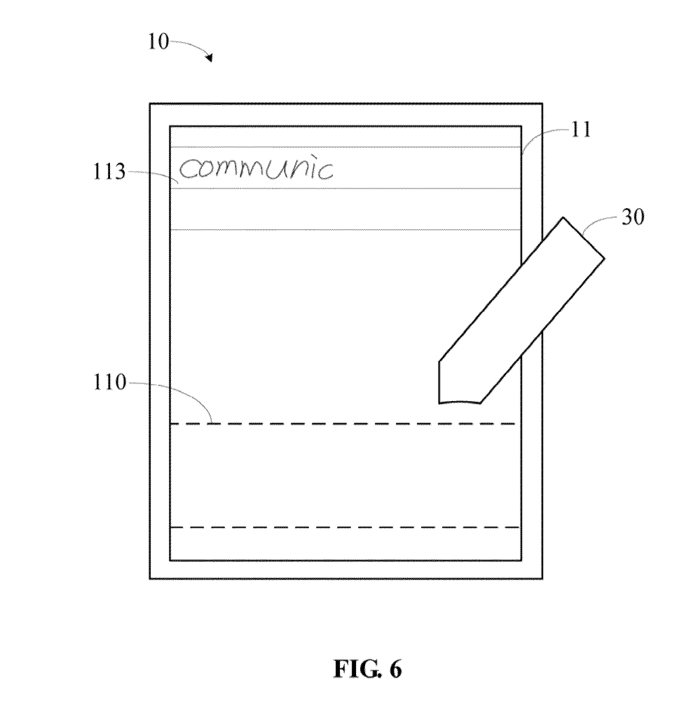

Referring to FIG. 6, if the coordinates are on the second operating point 111, the handwriting display module 126 determines the group of handwritten letters constituting a word and reduces the size of the word in the predetermined scaling factor, and displays the handwritten word with the reduced size in the display box 113. Then, the handwriting display module 126 erases the word displayed in the word inputting box 110, and cancels the word inputting box 110.

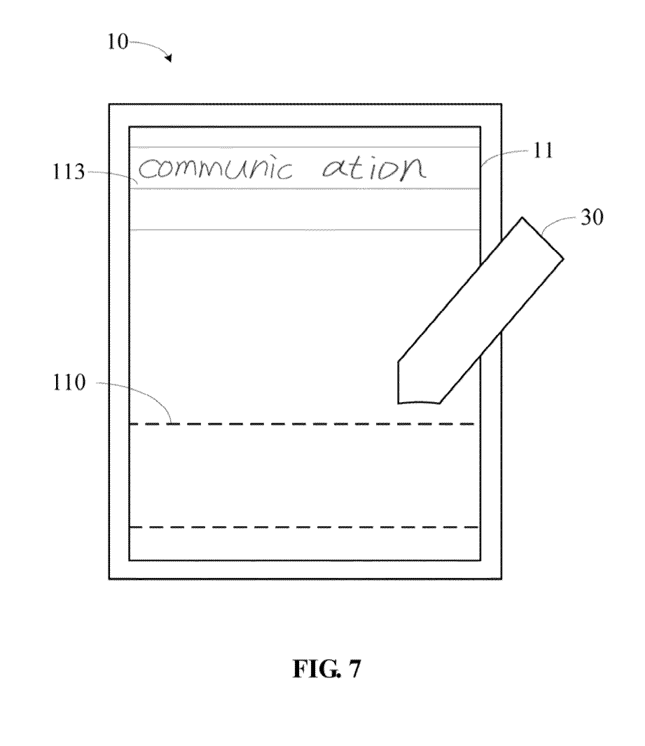

Referring to FIG. 7, when the coordinates are neither on the first operating point 111 nor on the second operating point 112, the handwriting display module 126 reduces the size of the word in the predetermined scaling factor, and displays the handwritten letters with the reduced size in the display box 113. Then, the handwriting display module 126 erases the word in the word inputting box 110. The word inputting box 110 continues to receive input of a second word and displays the input word. When the input of the second word finishes, the handwriting display module 126 zooms out the second word in the predetermined scaling factor, and controls the touch display screen 11 to display the zoomed out second word in the display box 113, the second word has the normal spacing from the word which has been displayed thereon, therefore they are taken as two separated words rather one word by users.

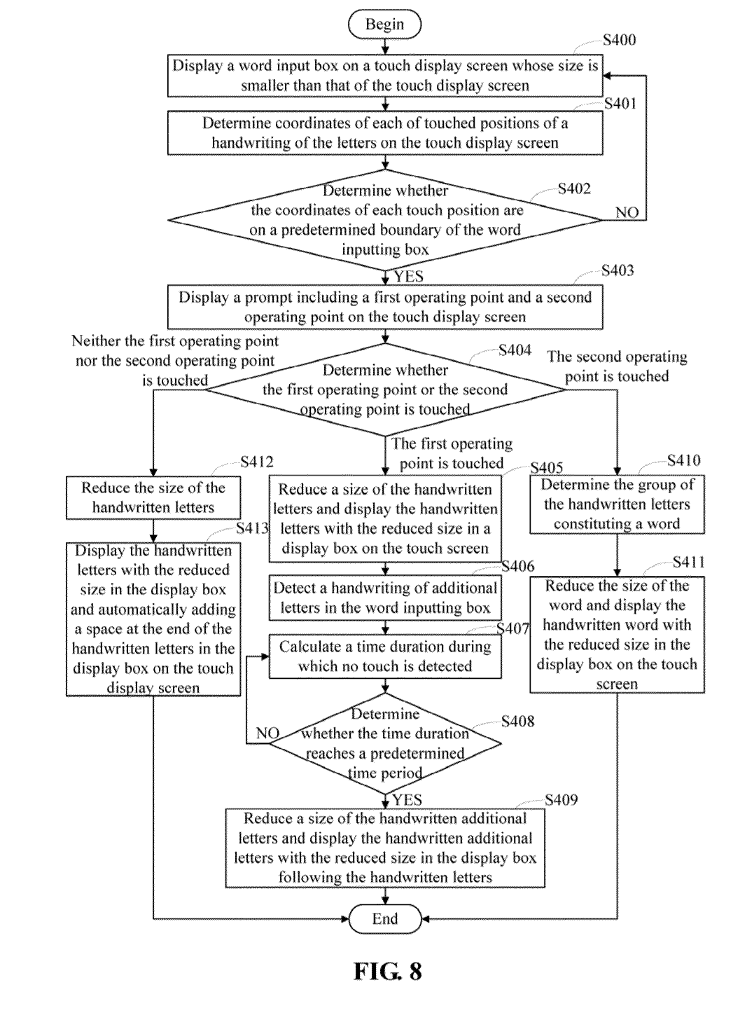

Referring to FIG. 8, a method for processing handwriting input is provided.

In step S400, the word inputting box determining module 120 controls to display the word inputting box 110 on the touch display screen 11 for allowing the user to handwrite the letters therein.

The storage unit 15 has a pre-stored word inputting box defining condition for defining an word inputting box 110. The input determining module 120 determines the extent of the word inputting box 110 according to the word inputting box defining condition stored in the storage unit 15. In the embodiment, according to the word inputting box defining condition, the size of the word inputting box 110 is equal to that of the touch display screen 11. In an alternative embodiment, according to the word inputting box defining condition, the size of the word inputting box 110 is smaller than that of the touch display screen 11 and is centered by the initial touch position.

In step S401, the touch analyzing unit 14 determines coordinates of the touch positions in response to the touch signals generated by the touch display screen 11, and transmits the coordinates so determined to the coordinate receiving module 121.

In step S402, the boundary determining module 124 determines whether the coordinates received by the coordinate receiving module 121 are on a predetermined boundary of the word inputting box 110 according to the word inputting box defining condition stored in the storage unit 15. If yes, the procedure goes to step S403, otherwise, the procedure returns to step S400.

In step S403, the prompting display module 125 generates a prompt including the first operating point 111 and the second operating point 112, and the display control unit 13 controls the touch display screen 11 to display the first operating point 111 and the second operating point 112 at the same time on a boundary of the word inputting box 110.

In step S404, the handwriting display module 126 determines whether coordinates determined by the touch analyzing unit 14 in response to a user's touch when the prompt is displayed on the touch display screen 11 is on the first operating point 111 or on the second operating point 112. If the coordinates are on the first operating point 111, the procedure goes to step S405, if the coordinate is on the second operating point 112, the procedure goes to step S410, and otherwise, the procedure goes to step S412.

In step S405, the handwriting display module 126 reduces a size of the handwritten letters in the predetermined scaling factor, and displays the handwritten letters with the reduced size in the display box 113. Then, the handwriting display module 126 erases the handwritten letters displayed in the word inputting box 110.

The words are input by the input device 20 before the prompt is displayed on the touch display screen 11, and determined by the handwriting recognizing module 123 to be displayed on the word inputting box 110.

In step S406, the touch analyzing unit 14 detects the user's handwriting of a second word in the word inputting box 110 after the handwritten letters with the reduced size is displayed in the display box 113.

In step S407, the time calculating unit 16 calculates a time duration during which no touch is detected by the input determining module 122.

In step S408, the input determining module 122 determines whether the time tracked by the time calculating unit 16 reaches a predetermined time to determine whether the input of a word is finished. If yes, the procedure goes to step S409, otherwise, the procedure returns back to step S407.

In step S409, the handwriting display module 126 reduces a size of the second word out in the predetermined scaling factor, and controls the touch display screen 11 to display the second word with the reduced size in the display box 113, immediately following the word which had been displayed thereon, to combine the original word with the second word to form a whole word. The second word immediately following the original word to form a whole word means that the space between the last character of the original word and the first character of the second word is much less than a space therebetween when they are two separate words. Then the procedure ends.

In step S410, the handwriting display module 126 determines the group of the handwritten letters constituting a word.

In step S411, the handwriting display module 126 reduces the size of the word in the predetermined scaling factor, and displays the handwritten word with the reduced size in the display box 113. Then, the handwriting display module 126 erases the word displayed in the word inputting box 110, and cancels the word inputting box 110, then the procedure ends.

In step S412, the handwriting display module 126 reduces the size of the handwritten letters in the predetermined scaling factor.

In step S413, the handwriting display module 126 displays the handwritten letters with the reduced size in the display box 113, and automatically adding a space at the end of the handwritten letters in the display box 113 on the touch display screen 11. The handwriting display module 126 erases the word in the word inputting box 110. Then the procedure ends.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus for processing handwriting input comprising:
a touch display screen configured for detecting touched positions on the touch display screen when the touch display screen is in a word inputting mode;
a display control unit;
a touch analyzing unit configured for determining coordinates of each of the detected touched positions; and
a processing unit comprising:
a coordinate receiving module configured for receiving the coordinates determined by the touch analyzing unit;
a handwriting recognizing module configured for recognizing letters handwritten by a user;
a word inputting box determining module configured for controlling displaying a word inputting box on the touch display screen for allowing the user to handwrite the letters therein;
a boundary determining module configured for determining whether the coordinates of each touched position are on a predetermined boundary of the word inputting box;
a prompting display module configured for controlling displaying a prompt including a first operating point on the touch display screen if the coordinates of one touched position are on the predetermined boundary of the word inputting box; and
a handwriting display module configured for determining whether the first operating point is touched, and reducing a size of the handwritten letters and controlling the display control unit to display the handwritten letters with the reduced size in a display box displayed on the touch display screen, erasing the handwritten letters in the word inputting box to allow the user to handwrite addition letters, reducing a size of the handwritten additional letters, and controlling the display control unit to display the additional letters with the reduced size in the display box at the end of the handwritten letters.

2. The apparatus for processing handwriting input as claimed in claim 1, wherein the prompting further comprises a second operating point, the handwriting display module is further configured for determining whether the second operating point is touched, determining the group of handwritten letters constituting a word if the second operating point is touched; reducing the size of the word; and displaying the handwritten word with the reduced size in the display box on the touch display screen.

3. The apparatus for processing handwriting input as claimed in claim 2, wherein the handwriting display module is further configured for reducing the size of the handwritten letters if a touch by the user on the touch display screen is neither on the first operating point nor on the second operating point, and displaying the handwritten letters with the reduced size in the display box; and automatically adding a space at the end of the handwritten letters in the display box.

4. The apparatus for processing handwriting input as claimed in claim 3, wherein the first operating point and the second operating point are displayed on the predetermined boundary of the word inputting box.

5. The apparatus for processing handwriting input as claimed in claim 1, further comprising a time calculating unit, and the processing unit further comprises an input determining module, the input determining module is configured for activating the time calculating unit to calculate an elapse time of the touch analyzing unit not receiving any touch signal, determining whether the elapse time tracked by the time calculating unit reaches a predetermined time to judge whether the input of a word is finished, and handwriting recognizing module determines the input of the word is finished when the elapse time reaches the predetermined time, and the handwriting display module zooms out the word in the predetermined scaling factor and displays the zoomed out word in the display box.

6. The apparatus for processing handwriting input as claimed in claim 1, wherein the size of the word inputting box is equal to the size of the touch display screen.

7. The apparatus for processing handwriting input as claimed in claim 1, wherein the size of the word inputting box is smaller than the size of the touch display screen.

8. A method for processing handwriting input through a touch display screen, the method comprising:
displaying a word inputting box on the touch display screen for allowing a user to handwrite a group of letters within the word inputting box, the size of the word inputting box being smaller than that of the touch display screen;
determining coordinates of each of touched positions of the handwriting of the letters on the touch display screen;
determining whether the coordinates of each touch position are on a predetermined boundary of the word inputting box;
displaying a prompt including a first operating point on the touch display screen if the coordinates of one touch position is on the predetermined boundary of the word inputting box;
detecting whether the displayed first operating point is touched;
reducing a size of the handwritten letters, and displaying the handwritten letters with the reduced size in a display box on the touch display screen if the displayed first operating point is touched; and
detecting the user's handwriting of additional letters in the word inputting box after the handwritten letters with the reduced size is displayed in the display box;
reducing a size of the handwritten additional letters, and displaying the handwritten additional letters with the reduced size in the display box immediately following the handwritten letters.

9. The method as claimed in claim 8, wherein the prompt further comprises a second operating point, the method further comprising:
detecting whether the second operating point is touched;
determining the group of handwritten letters constituting a word if the second operating point is touched; and
reducing the size of the word and displaying the handwritten word with the reduced size in the display box on the touch display screen.

10. The method as claimed in claim 9, further comprising:
reducing the size of the handwritten letters if neither the first operating point nor the second operating point is touched; and
displaying the handwritten letters with the reduced size in the display box, and automatically adding a space at the end of the handwritten letters in the display box on the touch display screen.

11. The method as claimed in claim 8, further comprising:
calculating a time duration during which no touch is detected after the inputting of the additional letters; and
determining whether the time duration reaches a predetermined time period; wherein the size of the handwritten additional letters is reduced if the time duration reaches a predetermined time period.
